(19) United States
(12) Patent Application Publication
(10) Pub. No.: US 2004/0124065 A1
(43) Pub. Date: Jul. 1, 2004

(54) Coin distinguishing method and device

(76) Inventor: Masanori Sugata, Saitama (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/474,511

(22) PCT Filed: Apr. 24, 2002
(86) PCT No.: PCT/JP02/04056

(30) Foreign Application Priority Data
Apr. 25, 2001 (JP) 2001-127771

(51) Int. Cl. G07D 5/00

(52) U.S. Cl. 194/328

(57) ABSTRACT

A coin distinguishing method capable of distinguishing a cyclic linear uneven pattern or a character imprint formed on the side of a coin with a high accuracy and at a high speed. The side of a coin (C) falling through a coin passage (101) in an advancing direction is irradiated with a light (105) from a flash shooting light source (104), a reflection light (106) reflected off the side of the coin (C) is input to an image sensor (107) to obtain the image of the side of the coin (C), images obtained by a vertical-direction projection operation unit (110) and an oblique-direction projection operation unit (111) are subjected to projection operation, the presence/absence of mills of the coin (C) is judged by a mill pitch detection unit (112) based on two one-dimension waveforms obtained from the projection results, the directions of the mills of the coin (C) are judged by a mill-direction detection unit (113), and the coin (C) is distinguished by a distinguishing unit (115) based on the results of judging.

### TECHNICAL FIELD

The present invention relates to a coin distinguishing method and device, and more particularly to a coin distinguishing method and device for distinguishing a coin based on a cyclic linear uneven pattern or a character imprint formed on the side of the coin.

### BACKGROUND ART

Generally, automatic vending machines, money changers and the like using coins are required to distinguish denomination and authenticity of inserted coins.

Conventionally, such a type of coin distinguishing device is configured to have a single or plural magnetic sensors disposed at a coin passage through which coins inserted through a coin insertion slot pass, to distinguish the material, thickness, size, presence/absence of a hole and the like of the coin by the magnetic sensors, and to distinguish the denomination and authenticity of the coin based on the distinguished result.

Besides, it is also proposed to configure to detect a thickness, a size and the like of the coin by an optical sensor such as an image pickup device.

In recent years, however, altered coins, which are foreign currency having a material and a shape similar to those of domestic specie and modified so to have a pattern similar to that of the domestic specie obtained by an optical sensor or a magnetic sensor, are spreading. And, as the altered coins have become having a higher machining accuracy, a problem of difficulty in distinguishing authenticity by a conventional magnetic sensor or optical sensor is occurring. Especially, misuse of foreign currency has become a serious problem because 500-yen coins are coins of large denominations.

Therefore, to distinguish such altered coins, it is necessary to distinguish such coins with a higher accuracy. The presence/absence and direction of the shape of the side of a coin, namely a cyclic linear uneven pattern (hereinafter called as the mill), are considered as one element for distinguishing the coin.

For example, Japanese Patent Laid-Open No. 9-167270 discloses a method for detecting the presence/absence of a mill by which the side of a coin is irradiated with light, reflected light is detected by an optical sensor to obtain an image of the side of the coin, pixels configuring the obtained image and each having a value of a prescribed threshold value or higher are measured, and it is judged that the coin has the mill when the number of pixels measured is large or it is judged that the coin does not have a mill and a character imprint formed when the number of pixels is small.

Japanese Patent Laid-Open No. 9-171572 discloses a method for detecting the presence/absence of a mill, which irradiates light from a laser diode, detects a reflection light by a photodiode to obtain an image signal of the side of a coin, measures the number of peaks in the waveform of the obtained image signal, judges that the coin has a mill when cyclic peaks are measured, judges that the coin does not have a mill when no peak is measured or judges that the coin has a character imprint when uneven peaks are measured.

But, the prior art disclosed in the above-described Japanese Patent Laid-Open No. 9-167270 and Japanese Patent Laid-Open No. 9-171572 have a difficulty in detecting a direction of the mill, so that they cannot distinguish, for example, a new 500-yen coin having an oblique mill from another coin having a vertical mill.

### DISCLOSURE OF THE INVENTION

Accordingly, it is an object of the present invention to provide a coin distinguishing method and device capable of distinguishing an oblique mill with a high accuracy and at a high speed based on the number of peaks, cyclicity of peaks and intensity ratio of two one-dimensional waveforms generated by obtaining an image of the side of a coin by an optical sensor and conducting a vertical-direction projection operation and an oblique-direction projection operation with respect to the surface of the coin from the obtained image.

To achieve the above object, the invention of claim 1 provides a coin distinguishing method, characterized by comprising: irradiating a side of a subject coin with light; receiving reflection light from the side of the subject coin by an optical sensor to obtain an image of the side of the subject coin; conducting a projection operation in a direction perpendicular to the side of the subject coin and a projection operation in a direction oblique with a prescribed angle to the side of the subject coin on the obtained image; and distinguishing the subject coin based on two one-dimensional waveforms obtained from the results of the projection operations.

Here, the direction oblique with the prescribed angle to the side is, for example, the same direction as the oblique mill on the side of the new 500-yen coin.

The invention of claim 2 relates to the invention of claim 1, characterized in that: peak values, peak cyclicity and intensity ratio are detected from the two of one-dimensional waveforms obtained from the results of the projection operations; the presence/absence of a pattern formed on the side of the subject coin is judged based on the detected peak values and peak cyclicity; and a direction of the pattern formed on the side of the subject coin is judged based on the detected intensity ratio.

The invention of claim 3 relates to the invention of claim 2, characterized in that the intensity ratio and an intensity ratio of the subject coin previously detected are compared to judge the direction of the pattern formed on the side of the subject coin.

The invention of claim 4 relates to the invention of claim 1, characterized in that: the number of peaks and peak cyclicity are detected from the two one-dimensional waveforms obtained from the results of the projection operations; and the pattern formed on the side of the subject coin is distinguished by comparing with the number of peaks and peak cyclicity of the subject coin previously detected.

The invention of claim 5 provides a coin distinguishing device, characterized by comprising: a light source for irradiating a side of a subject coin with light; an optical sensor for obtaining an image of the side of the subject coin by receiving a reflection light from the side of the subject coin; projection operation means for conducting a projection operation in a direction perpendicular to the side of the subject coin and a projection operation in a direction oblique with a prescribed angle to the side of the subject coin on the obtained image; and distinguishing means for distinguishing the subject coin based on two of one-dimensional waveforms obtained from results of the operations by the projection operation means.

The invention of claim 6 relates to the invention of claim 5, characterized in that the distinguishing means comprises: detection means for detecting peak values, peak cyclicity and intensity ratio from the two one-dimensional waveforms obtained from the results of operation by the projection operation means; pattern presence/absence distinguishing means for judging the presence/absence of a pattern formed on the side of the subject coin based on the peak values and the peak cyclicity detected by the detection means; and pattern direction distinguishing means for judging a direction of the pattern formed on the side of the subject coin based on the intensity ratio detected by the detection means.

The invention of claim 7 relates to the invention of claim 6, characterized in that the pattern direction distinguishing means compares the intensity ratio with an intensity ratio of the subject coin previously detected to judge the direction of the pattern formed on the side of the subject coin.

The invention of claim 8 relates to the invention of claim 5, characterized in that the distinguishing means detects the number of peaks and the peak cyclicity from the two one-dimensional waveforms obtained from the operation results by the projection operation means, and distinguishes the pattern formed on the side of the subject coin by comparing with the number of peaks and peak cyclicity of the subject coin previously detected.

Thus, according to the present invention, the image of the side of the coin is obtained, and the projection operation in the direction perpendicular and the projection operation in the direction oblique to the surface of the coin from the obtained image are conducted to generate the two one-dimensional waveforms, from which the number of peaks, the cyclicity of peaks and the oblique mill degree are detected to enable to distinguish the pattern shape formed on the side of the coin, so that the oblique mill can be distinguished with a high accuracy and at a high speed, and the coin distinguishing accuracy can be improved substantially.

### BRIEF DESCRIPTION OF THE DRAWINGS

FIG. 1 is a diagram showing a schematic structure of the coin distinguishing device according to the invention;

FIG. 2 is a diagram showing an image of the side of a coin C obtained by an image sensor;

FIG. 3 is a diagram having graphed two one-dimensional waveforms, which are generated by a projection operation of the image of a character imprint formed coin, which is obtained by the image sensor, by a vertical-direction projection operation unit and an oblique-direction projection operation unit;

FIG. 4 is a diagram having graphed two one-dimensional waveforms, which are generated by a projection operation of the image of an oblique mill formed coin, which is obtained by the image sensor, by the vertical-direction projection operation unit and the oblique-direction projection operation unit;

FIG. 5 is a diagram having graphed two one-dimensional waveforms, which are generated by a projection operation of the image of a vertical mill formed coin obtained by the image sensor, by the vertical-direction projection operation unit and the oblique-direction projection operation unit; and

FIG. 6 is a flow chart showing an operation procedure of a distinguishing unit for judging the presence/absence and direction of the mill.

### BEST MODE FOR CARRYING OUT THE INVENTION

An embodiment of the coin distinguishing method and device according to the present invention will be described in detail with reference to the accompanying drawings.

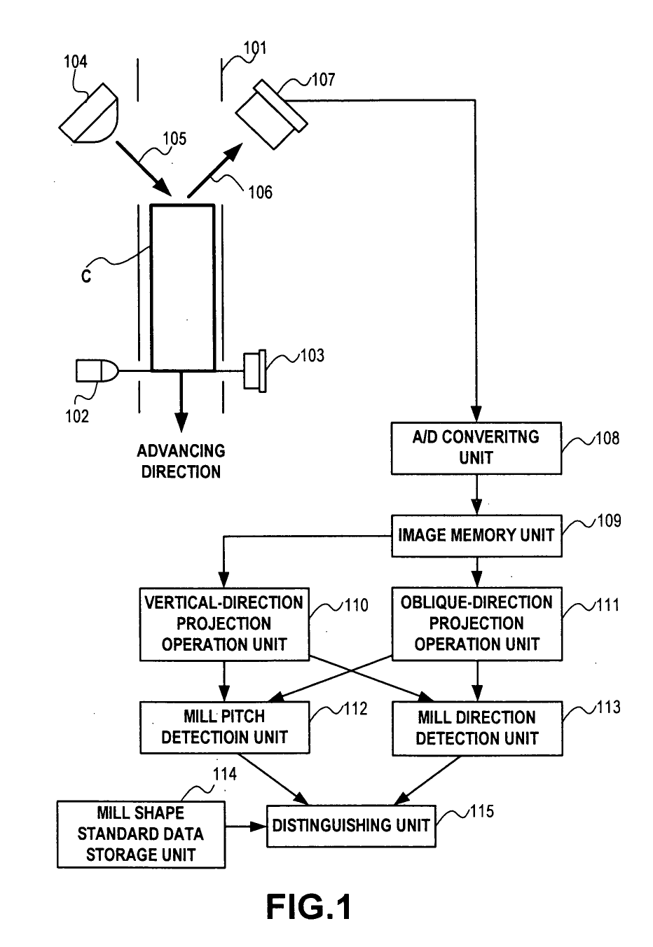

FIG. 1 is a diagram showing a schematic structure of the coin distinguishing device according to the invention.

As shown in FIG. 1, the coin distinguishing device according to the invention is comprised of a coin passage 101 for falling a subject coin C (hereinafter called the coin C) in a direction indicated by an arrow in the drawing; a light-emitting device 102 and an outer end detection sensor 103 for detecting the arrival of the end of the coin; a flash shooting light source 104 for irradiating the side of the coin C with light 105 in pulse form; an image sensor 107 for obtaining an image signal of the side of the coin C by inputting reflection light 106 of the light 105 reflected from the side of the coin C; an A/D converting unit 108 for converting the obtained image signal of the side of the coin C into a digital image signal; an image memory unit 109 for temporarily storing the digitized image signal; a vertical-direction projection operation unit 110 for generating a one-dimensional waveform by conducting a projection operation in the thickness direction (hereinafter called the vertical direction) of the coin C from the stored image signal; an oblique-direction projection operation unit 111 for generating a one-dimensional waveform by conducting a projection operation in the same direction (hereinafter called the oblique direction) as the oblique mill on the side of a new 500-yen coin from the stored image signal; a mill pitch detection unit 112 for detecting the presence/absence and a pitch of the mill of the coin C based on the two one-dimensional waveforms generated by the vertical-direction projection operation unit 110 and the oblique-direction projection operation unit 111; a mill direction detection unit 113 for detecting a direction of the mill of the coin C based on an intensity ratio (hereinafter called the oblique mill degree) of the two one-dimensional waveforms generated by the vertical-direction projection operation unit 110 and the oblique-direction projection operation unit 111; and a distinguishing unit 115 for distinguishing the coin C by comparing the mill data on the coin C detected by the mill pitch detection unit 112 and the mill direction detection unit 113 with standard data on the mill of a subject coin to be distinguished and previously stored in a mill shape standard data storage unit 114.

In the above configuration, the light-emitting device 102 and the outer end detection sensor 103 are disposed to mutually oppose at both sides of the holes formed in the coin passage 101

When the coin C is inserted into the coin distinguishing device according to the present invention, the coin C falls freely through the coin passage 101, the coin C falling freely through the coin passage 101 blocks light entering from the light-emitting device 102 into the outer end detection sensor 103, and the outer end detection sensor 103 produces a detection output signal to illuminate the flash shooting light source 104 in synchronization with the detection output signal.

In the above case, an illumination time of the flash shooting light source 104 is set to a short time corresponding to a response time of the image sensor 107, so that the image sensor 107 can obtain a still image of the coin C falling freely through the coin passage 101. The image sensor 107 is already through a standby state immediately before the flash shooting light source 104 is turned on.

And, in the above embodiment, the coin C is distinguished based on the image signal corresponding to the still image of the coin C.

In the above embodiment, the free fall of the coin C through the coin passage 101 was described as an example. But, it is also possible to configure to roll the coin C along the bottom surface of the coin passage 101 which is inclined. In such a case, by momentary lighting of the flash shooting light source 104, the still image of the coin C rolling in the same way as the above-described embodiment can be obtained by the image sensor 107.

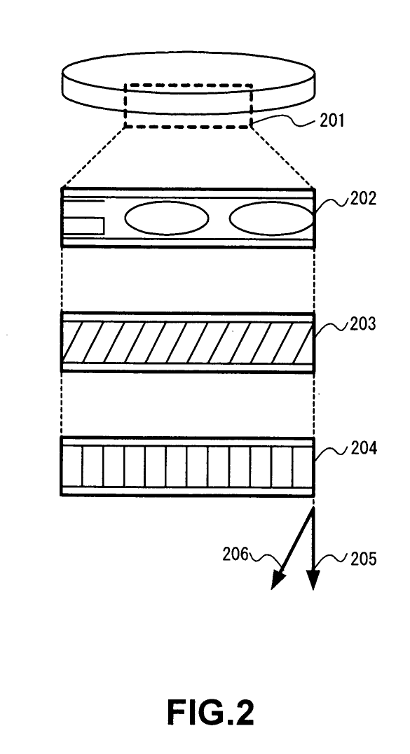

FIG. 2 is a diagram showing an image of the side of the coin C obtained by the image sensor.

As shown in FIG. 2, the image sensor 107 is fixed to the coin passage 101, and an image pickup area 201 for the image of the coin C is also fixed. Here, the image of the image pickup area 201 is divided into an image including the side of the coin C and a background image.

Numeral 202 indicates an image of a coin (e.g., an old 500-yen coin) having a character and the like imprint on the side, 203 indicates a cyclic linear uneven pattern having a prescribed angle to a direction parallel to the surface of the coin, namely an image of a coin (e.g., a new 500-yen coin) having an oblique mill imprinted on the side, and 204 indicates a cyclic linear uneven pattern vertical to the surface of a coin, namely an image of a coin (e.g., a 100-yen coin, a foreign currency or the like) having a vertical mill imprint formed on the side.

And, the direction in that the image of the side of the coin C is subjected to a projection operation is indicated by a vertical direction arrow 205 and an oblique direction arrow 206.

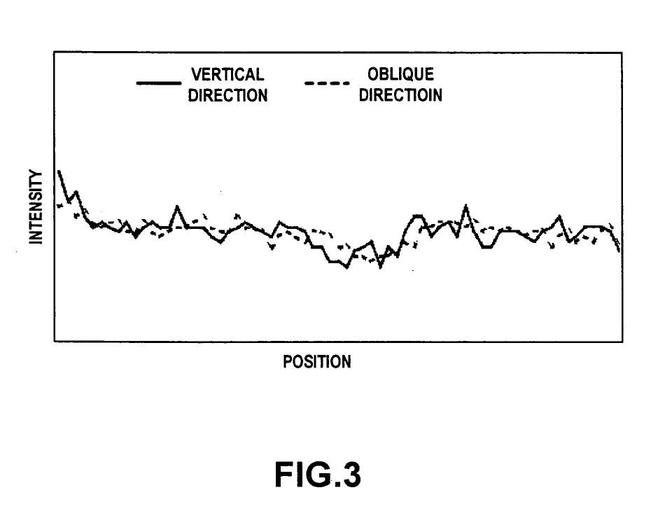

FIG. 3 is a diagram in a graph form of two one-dimensional waveforms generated by a projection operation of the character imprint coin image, which is obtained by the image sensor, by the vertical-direction projection operation unit 110 and the oblique-direction projection operation unit 111.

As shown in FIG. 3, the one-dimensional waveform graph of the character imprint coin does not indicate a large difference of amplitude between the two one-dimensional waveforms or cyclicity.

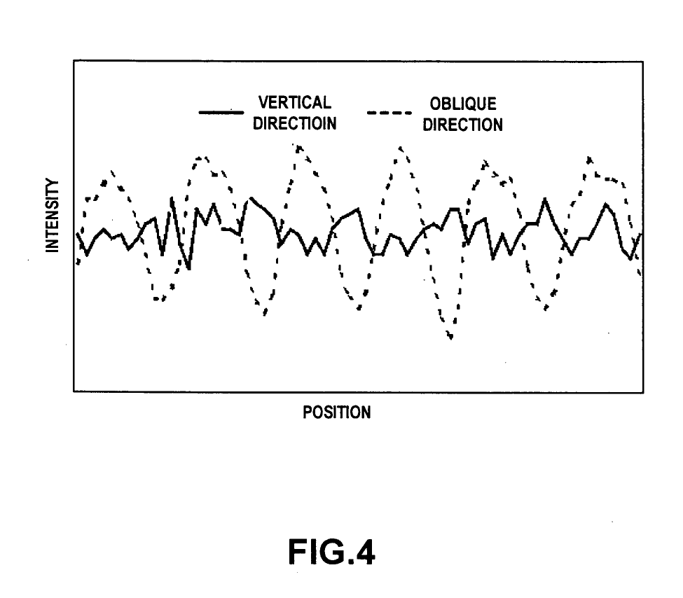

FIG. 4 is a diagram in a graph form of two one-dimensional waveforms generated by a projection operation of the oblique mill coin image, which is obtained by the image sensor, by the vertical-direction projection operation unit 110 and the oblique-direction projection operation unit 111.

As shown in FIG. 4, the graph of the one-dimensional waveform of the oblique mill coin indicates that the one-dimensional waveform generated by the oblique-direction projection operation has a larger amplitude and also cyclicity as compared with the one-dimensional waveform generated by the vertical-direction projection operation.

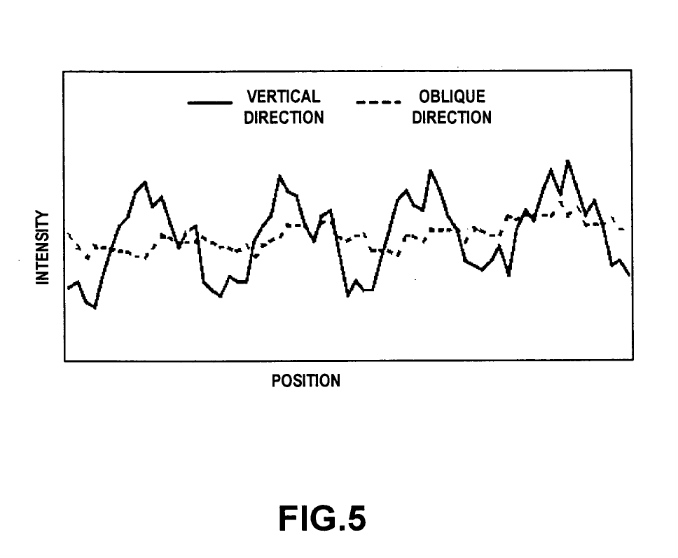

FIG. 5 is a diagram in a graph form of two one-dimensional waveforms generated by a projection operation of the vertical mill coin image, which is obtained by the image sensor, by the vertical-direction projection operation unit 110 and the oblique-direction projection operation unit 111.

As shown in FIG. 5, the graph of the one-dimensional waveform of the vertical mill coin indicates that the one-dimensional waveform generated by the vertical-direction projection operation has a larger amplitude and also cyclicity as compared with the one-dimensional waveform generated by the oblique-direction projection operation.

The mill pitch detection unit 112 detects peaks from the two one-dimensional waveforms generated by the two direction projection operations from the image of the side of the coin C, obtains information on the peak values, the number of peaks per unit length and mill cyclicity from the detected peaks and outputs to the distinguishing unit 115. The peak detection method is not limited to a particular one in this invention.

The mill direction detection unit 113 determines the oblique mill degree by comparing the amplitude intensities of the two one-dimensional waveforms and outputs to the distinguishing unit 115.

Here, the oblique mill degree is a ratio of intensities (amplitudes) of the one-dimensional waveform generated by conducting the vertical-direction projection operation by the vertical-direction projection operation unit 110 and the one-dimensional waveform generated by conducting the oblique-direction projection operation by the oblique-direction projection operation unit 111.

It is assumed that a differential waveform of the one-dimensional waveform in the vertical direction is X11 to X1i and a differentiation waveform of the one-dimensional waveform in the oblique direction is X21 to X2i, then an oblique mill degree R is represented by the expression below.

R=Σ|X2i|/Σ|X1i|

The distinguishing unit 115 judges the presence/absence of the mill of the coin C based on the information on the peak values, the number of peaks per unit length and the mill cyclicity of the one-dimensional waveform of the coin C obtained by the mill pitch detection unit 112 and judges the direction of the mill based on the oblique mill degree R of the coin C determined by the mill direction detection unit 113.

When the image of the side of the coin is subjected to a projection operation in a prescribed direction and the coin has a mill formed on the side, the generated one-dimensional waveform has cyclic peaks. Besides, when the projection operation is conducted in a direction parallel to the mill direction, the one-dimensional waveform to be generated has a maximum peak value.

When the oblique mill degree R of the coil C is larger than an oblique mill degree R0 determined from the coin having an oblique mill previously stored in the mill shape standard data storage unit 114, it is judged that the coin C has an oblique mill, when the mill degree R of the coin C is smaller than the oblique mill degree R0 determined from the coin having the vertical mill previously stored in the mill shape standard data storage unit 114, it is judged that the coin C has a vertical mill, and when other than the above, it is judged that the coin C does not have a character impression or a mill.

By determining the above criteria, the distinguishing unit 115 distinguishes the coin C. The procedure of the coin distinguishing performed by the coin distinguishing device according to the invention will be described in an embodiment having a 500-yen coin as the coin to be distinguished.

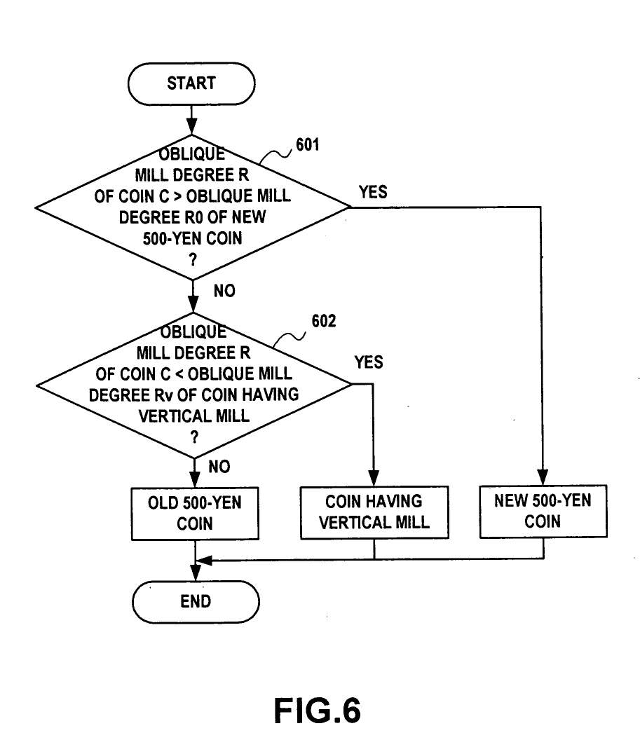

FIG. 6 is a flow chart showing an operation procedure of the distinguishing unit for distinguishing a direction of the mill.

The oblique mill degree R of the coin C is compared with the oblique mill degree Ro previously determined from the new 500-yen coin (step 601), and when the oblique mill degree R of the coin C is larger than the oblique mill degree Ro previously determined from the new 500-yen coin (YES in step 601), it is judged that the coin C is a new 500-yen coin.

When the oblique mill degree R of the coin C is smaller than the oblique mill degree Ro previously determined from the new 500-yen coin (NO in step 601), the oblique mill degree R of the coin C is compared with an oblique mill degree Rv determined from the coin having the vertical mill (step 602), and when the oblique mill degree R of the coin C is smaller than the oblique mill degree Rv determined from the coin having the vertical mill (YES in step 602), it is judged that the coin C has a vertical mill.

When the oblique mill degree R of the coin C is larger than the oblique mill degree Rv determined from the coin having the vertical mill (NO in step 602), it is judged that the coin C is an old 500-yen coin.

A coin can also be distinguished by previously determining a threshold range for judging a direction of the mill from the information on the number of peaks and cyclicity of the one-dimensional waveform of the new 500-yen coin and comparing the information on the number of peaks and cyclicity of the one-dimensional waveform of the coin C with the threshold range for judging the direction of the mill.

For example, when the number of peaks and cyclicity of the coin C are within the threshold range, it is judged that the coin C is a new 500-yen coin, and when the number of peaks of the coin C is outside of the threshold range and the cyclicity of the coin C is within the threshold range, it is judged that the coin is different from the new or old 500-yen coin, and when the number of peaks and cyclicity of the coin C are outside of the threshold range, it is judged that the coin is an old 500-yen coin.

Embodiments of the invention is not limited to the optical sensor output when the object image signal is a two-dimensional image but can also be applied in the same manner to a magnetic senor and the like if uneven two-dimensional information on the side of the coin can be obtained with the passage of a coin.

### Industrial Applicability

According to the present invention, it is configured that an image of the side of a coin is obtained, a projection operation in a direction vertical to and a projection operation in a direction oblique to the surface of the coin are conducted from the obtained image, and a pattern shape on the side of the coin is distinguished based on the number of peaks, cyclicity of peaks and oblique mill degrees detected from two one-dimensional waveforms generated. Therefore, it is possible to distinguish the oblique mill with a high accuracy and at a high speed and to substantially improve the distinguishing accuracy of the coin.

1. A coin distinguishing method, characterized by comprising:
irradiating a side of a subject coin with light;
receiving reflection light from the side of the subject coin by an optical sensor to obtain an image of the side of the subject coin;
conducting a projection operation in a direction perpendicular to the side of the subject coin and a projection operation in a direction oblique with a prescribed angle to the side of the subject coin on the obtained image; and
distinguishing the subject coin based on two one-dimensional waveforms obtained from the results of the projection operations.

2. The coin distinguishing method according to claim 1, characterized in that:
peak values, peak cyclicity and intensity ratio are detected from the two of one-dimensional waveforms obtained from the results of the projection operations;
the presence/absence of a pattern formed on the side of the subject coin is judged based on the detected peak values and peak cyclicity; and
a direction of the pattern formed on the side of the subject coin is judged based on the detected intensity ratio.

3. The coin distinguishing method according to claim 2, characterized in that the intensity ratio and an intensity ratio of the subject coin previously detected are compared to judge the direction of the pattern formed on the side of the subject coin.

4. The coin distinguishing method according to claim 1, characterized in that:
the number of peaks and peak cyclicity are detected from the two one-dimensional waveforms obtained from the results of the projection operations; and
the pattern formed on the side of the subject coin is distinguished by comparing with the number of peaks and peak cyclicity of the subject coin previously detected.

5. A coin distinguishing device, characterized by comprising:
a light source for irradiating a side of a subject coin with light;
an optical sensor for obtaining an image of the side of the subject coin by receiving a reflection light from the side of the subject coin;
projection operation means for conducting a projection operation in a direction perpendicular to the side of the subject coin and a projection operation in a direction oblique with a prescribed angle to the side of the subject coin on the obtained image; and
distinguishing means for distinguishing the subject coin based on two of one-dimensional waveforms obtained from results of the operations by the projection operation means.

6. The coin distinguishing device according to claim 5, characterized in that the distinguishing means comprises:
detection means for detecting peak values, peak cyclicity and intensity ratio from the two one-dimensional waveforms obtained from the results of operation by the projection operation means;
pattern presence/absence distinguishing means for judging the presence/absence of a pattern formed on the side of the subject coin based on the peak values and the peak cyclicity detected by the detection means; and
pattern direction distinguishing means for judging a direction of the pattern formed on the side of the subject coin based on the intensity ratio detected by the detection means.

7. The coin distinguishing device according to claim 6, characterized in that the pattern direction distinguishing means compares the intensity ratio with an intensity ratio of the subject coin previously detected to judge the direction of the pattern formed on the side of the subject coin.

8. The coin distinguishing device according to claim 5, characterized in that the distinguishing means detects the number of peaks and the peak cyclicity from the two one-dimensional waveforms obtained from the operation results by the projection operation means, and distinguishes the pattern formed on the side of the subject coin by comparing with the number of peaks and peak cyclicity of the subject coin previously detected.
